(19) United States
(12) Patent Application Publication
(10) Pub. No.: US 2022/0314812 A1
(43) Pub. Date: Oct. 6, 2022

(54) BRAKING CONTROL DEVICE FOR VEHICLE

(71) Applicant: ADVICS CO., LTD., Kariya-shi (JP)

(72) Inventors: Takayuki YAMAMOTO, Kariya-shi (JP); Kazutoshi YOGO, Kariya-shi (JP)

(73) Assignee: ADVICS CO., LTD., Kariya-shi (JP)

(21) Appl. No.: 17/630,794

(22) PCT Filed: Jul. 28, 2020
(86) PCT No.: PCT/JP2020/028809

§ 371 Date: Jan. 27, 2022

(30) Foreign Application Priority Data
Jul. 31, 2019 (JP) 2019-140878

(51) Int. Cl. B60L 7/26; B60T 13/58; B60T 8/17

(52) U.S. Cl. CPC B60L 7/26; B60T 13/586; B60T 8/17; B60T 2240/00; B60T 2270/604

(57) ABSTRACT

A braking control device is applied to, for example, a vehicle in which a regenerative braking force is generated on a front wheel by a regenerative generator provided on the front wheel. The braking control device includes an actuator configured to individually generate a front wheel friction braking force on the front wheel and a rear wheel friction braking force Fmr on a rear wheel of the vehicle; and a braking controller configured to control the actuator. In the braking control device, the braking controller is configured to regulate the front and rear wheel friction braking forces based on a normative regenerative force corresponding to a rotation speed equivalent value equivalent to a rotation speed of the regenerative generator.

### TECHNICAL FIELD

The present disclosure relates to a braking control device for a vehicle.

### BACKGROUND ART

PTL 1 discloses that, in order to “reduce total power consumption by reducing power consumption of a brake motor of an electric friction brake while maintaining a balance between generation and consumption of electrical energy in an auxiliary battery”, “a restriction flag is turned on and a start of the brake motor is prohibited during a period from the start of the brake motor to when a set time period elapses”.

PTL 1 discloses that “When an actual regenerative braking force Fm* is less than a required total braking force Fsref, a request for operating a friction brake (including a hydraulic brake 44 and an electric brake 40) is issued. A required friction braking force Faref is determined based on a value (Fsref−Fm*) obtained by subtracting the actual regenerative braking force Fm* from the required total braking force Fsref. When the required friction braking force Faref is greater than 0, hydraulic brakes 44FL and 44FR of front wheels 42FL and 42FR are actuated, and an actual hydraulic braking force Fp* increases as a required hydraulic braking force Fpref increases. When the actual hydraulic braking force Fp* reaches a set hydraulic braking force Fpth, the request for operating the electric brakes 40RL and 40RR of the rear wheels 4RL and 4RR is issued. A required electric friction braking force Feref is larger than 0, and a brake motor 54 is actuated. Both regenerative braking force Fm and electric friction braking force Fe are applied to the rear wheels 4RL and 4RR.”.

In PTL 1, the actual regenerative braking force Fm* (simply also referred to as a “regenerative braking force”) is maintained at a constant value upon increasing from “0” (see FIG. 5 in PTL 1). However, a regenerative braking force of a regenerative generator (which is also an “electric motor for traveling”) is limited by rating of a power transistor (IGBT or the like) that drives the regenerative generator, battery charge acceptance, and the like. When a traveling speed of a vehicle decreases and a rotation speed (rotational speed) of the regenerative generator decreases, the regenerative braking force decreases. That is, the regenerative braking force is a state quantity that is not constant and changes momentarily. Therefore, it is desired that the regenerative braking force generated by the regenerative generator is appropriately considered, and a regenerative cooperative control (a control in which the regenerative braking force and a friction braking force are suitably regulated) can be performed.

### CITATION LIST

### Patent Literature

PTL 1: WO2013/008298

### SUMMARY OF INVENTION

### Technical Problem

An object of the invention is to provide, in a vehicle provided with an energy regeneration device, a braking control device in which a regenerative cooperative control can be performed according to a change in a regenerative braking force.

### Solution to Problem

A braking control device for a vehicle according to the invention is applied to a vehicle in which a regenerative braking force (Fg) is generated on a front wheel (WHf) by a regenerative generator (GN) provided on the front wheel (WHf). The braking control device includes “an actuator (YU) configured to individually generate a front wheel friction braking force (Fmf) on the front wheel (WHf) and a rear wheel friction braking force (Fmr) on a rear wheel (WHr) of the vehicle”; and “a controller (ECU) configured to control the actuator (YU)”.

In the braking control device for a vehicle according to the invention, the controller (ECU) is configured to regulate the front and rear wheel friction braking forces (Fmf and Fmr) based on a normative regenerative force (Fz) corresponding to a rotation speed equivalent value (Ns) equivalent to a rotation speed (Ng) of the regenerative generator (GN). According to the above configuration, since the front and rear wheel friction braking forces Fmf and Fmr are regulated according to an operating state (that is, the rotation speed equivalent value Ns) of the generator GN, energy regeneration can be appropriately performed.

In the braking control device for a vehicle according to the invention, the controller (ECU) is configured to: when the regenerative braking force (Fg) does not reach the normative regenerative force (Fz), set both the front and rear wheel friction braking forces (Fmf and Fmr) to zero, and when the regenerative braking force (Fg) reaches the normative regenerative force (Fz), increase the rear wheel friction braking force (Fmr) from zero before increasing the front wheel friction braking force (Fmf) from zero. According to the above configuration, since a front-rear distribution of the braking force acting on an entire vehicle including the friction braking force and the regenerative braking force is appropriately regulated, steering stability of the vehicle can be secured.

A braking control device for a vehicle according to the invention is applied to a vehicle in which a regenerative braking force (Fg) is generated on a rear wheel (WHr) by a regenerative generator (GN) provided on the rear wheel (WHr). The braking control device includes “an actuator (YU) configured to individually generate a front wheel friction braking force (Fmf) on a front wheel (WHf) of the vehicle and a rear wheel friction braking force (Fmr) on the rear wheel (WHr)”; and “a controller (ECU) configured to control the actuator (YU)”.

In the braking control device for a vehicle according to the invention, the controller (ECU) is configured to regulate the front and rear wheel friction braking forces (Fmf and Fmr) based on a normative regenerative force (Fz) corresponding to a rotation speed equivalent value (Ns) equivalent to a rotation speed (Ng) of the regenerative generator (GN). According to the above configuration, since the front and rear wheel friction braking forces Fmf and Fmr are regulated according to an operating state (that is, the rotation speed equivalent value Ns) of the generator GN, energy regeneration can be appropriately performed.

In the braking control device for a vehicle according to the invention, the controller (ECU) is configured to: when the regenerative braking force (Fg) does not reach the normative regenerative force (Fz), set both the front and rear wheel friction braking forces (Fmf and Fmr) to zero, and when the regenerative braking force (Fg) reaches the normative regenerative force (Fz), increase the front wheel friction braking force (Fmf) from zero before increasing the rear wheel friction braking force (Fmr) from zero. According to the above configuration, since a front-rear distribution of the braking force acting on an entire vehicle is regulated appropriately, steering stability of the vehicle can be secured.

### BRIEF DESCRIPTION OF DRAWINGS

FIG. 1 is an overall configuration diagram showing a braking control device for a vehicle according to a first embodiment of the invention.

FIG. 2 is a control flowchart showing processing of a pressure regulation control including a regenerative cooperative control according to the first embodiment.

FIG. 3 is a time-series line graph showing transition of a friction braking force and a regenerative braking force according to the first embodiment.

FIG. 4 is an overall configuration diagram showing a braking control device for a vehicle according to a second embodiment of the invention.

FIG. 5 is a control flowchart showing processing of a pressure regulation control including a regenerative cooperative control according to the second embodiment.

FIG. 6 is a time-series line graph showing transition of a friction braking force and a regenerative braking force according to the second embodiment.

### DESCRIPTION OF EMBODIMENTS

### Reference Numerals of Components, Etc. and Subscripts at Ends of Reference Numerals

In the following description, components, calculation processing, signals, characteristics, and values denoted by the same reference numerals, such as “CW”, have the same functions. Subscripts “f” and “r” appended to the ends of reference numerals related to wheels are comprehensive reference numerals indicating which wheel the reference numerals are related to in a front-rear direction of the vehicle. Specifically, “f” is related to a front wheel and “r” is related to a rear wheel. For example, among wheel cylinders, front wheel cylinders are denoted by CWf and rear wheel cylinders are denoted by CWr. Further, the subscripts “f” and “r” may be omitted. In this case, each reference numeral represents a general term.

In a connection path HS described later, a side close to a master reservoir RV (a side away from a wheel cylinder CW) is referred to as an “upper portion”, and a side close to the wheel cylinder CW is referred to as a “lower portion”. In addition, in a recirculation path HK in which a braking fluid BF circulates, a side close to a discharge portion Bt of a fluid pump HP is referred to as an “upstream (upstream portion)”, and a side away from the discharge portion Bt is referred to as a “downstream (downstream portion)”.

### First Embodiment of Braking Control Device for Vehicle

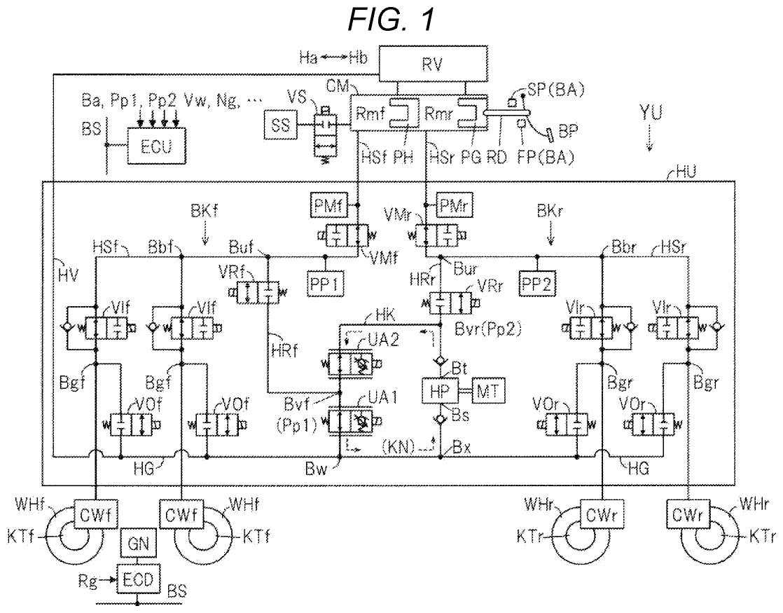

A braking control device SC according to a first embodiment of the invention will be described with reference to an overall configuration diagram in FIG. 1. In the first embodiment, in a two-system fluid path (braking systems), a front wheel braking system BKf is connected to wheel cylinders CWf of front wheels WHf, and a rear wheel braking system BKr is connected to wheel cylinders CWr of rear wheels WHr. That is, a front-rear type (also referred to as “type II”) fluid path is used as the two-system fluid path.

The front wheel WHf of the vehicle is provided with an electric motor GN for driving (traveling). That is, the vehicle is an electric vehicle such as a hybrid vehicle or an electric vehicle. The electric motor GN for traveling also functions as a generator (electric generator) for energy regeneration. The electric motor/generator GN is controlled by a drive controller ECD. In the braking control device SC, a regenerative cooperative control is performed. The “regenerative cooperative control” refers to that a regenerative braking force Fg of the generator GN and a friction braking force Fm (=Fmf and Fmr) generated by a braking hydraulic pressure Pw (=Pwf and Pwr) are controlled in cooperation with each other.

The vehicle equipped with the braking control device SC is provided with a braking operation member BP, rotating members KT, the wheel cylinders CW, a master reservoir RV, a master cylinder CM, a braking operation amount sensor BA, and a wheel speed sensor VW (not shown).

The braking operation member (for example, a brake pedal) BP is a member to be operated by a driver to decelerate the vehicle. By operating the braking operation member BP, a braking torque Tqf of the front wheel WHf and a braking torque Tqr of the rear wheel WHr are regulated, and a braking force is generated on a wheel WH. Specifically, the rotating member (for example, a brake disc) KT is fixed to the wheel WH of the vehicle. Then, brake calipers are provided so as to sandwich the rotating member KT.

The brake calipers are provided with the front and rear wheel cylinders CWf and CWr (=CW). By increasing pressures (front and rear wheel braking hydraulic pressures) Pwf and Pwr (=Pw) of the braking fluid BF in the front and rear wheel cylinders CW, a friction member (for example, a brake pad) is pressed against the rotating member KT. Since the rotating member KT and the wheel WH are fixed so as to rotate integrally, the braking torques Tqf and Tqr are generated on the front and rear wheels WHf and WHr by frictional forces generated at this time, respectively. Further, the friction braking forces Fmf and Fmr (=Fm) are generated on the front and rear wheels WHf and WHr by the front and rear wheel braking torques Tqf and Tqr, respectively.

The master reservoir (also referred to as an “atmospheric pressure reservoir”) RV is a tank for a working fluid, and the braking fluid BF is stored therein. The master cylinder CM is mechanically connected to the braking operation member BP via a brake rod RD or the like. A tandem type master cylinder is used as the master cylinder CM. An inside of the tandem type master cylinder CM is divided into two hydraulic chambers (front and rear wheel hydraulic chambers) Rmf and Rmr by a primary piston PG and a secondary piston PH. When the braking operation member BP is not operated, the front and rear wheel hydraulic chambers Rmf and Rmr (also referred to as a “master cylinder chamber”) of the master cylinder CM and the master reservoir RV are in a communicated state. At this time, the braking fluid BF is supplied from the master reservoir RV to the front and rear wheel hydraulic chambers Rmf and Rmr.

The front wheel hydraulic chamber Rmf of the tandem type master cylinder CM and the front wheel cylinders CWf are connected by a front wheel connection fluid path HSf (simply also referred to as a “front wheel connection path”). The rear wheel hydraulic chamber Rmr and the rear wheel cylinders CWr are connected by a rear wheel connection fluid path HSr (simply also referred to as a “rear wheel connection path”). Herein, the “fluid path” is a path for the braking fluid BF, which is a working liquid, to flow through, and corresponds to a braking pipe, a flow path of a fluid unit, a hose, or the like. The front and rear wheel connection paths HSf and HSr branch into two parts at branch portions Bbf and Bbr, respectively, the two parts of the front wheel connection path HSf are connected to the front wheel cylinders CWf, and the two parts of the rear wheel connection path HSr are connected to the rear wheel cylinders CWr.

The braking operation amount sensor BA detects an operation amount Ba of the braking operation member (brake pedal) BP operated by the driver. Specifically, as the braking operation amount sensor BA, at least one of front and rear wheel master cylinder hydraulic pressure sensors PMf and PMr, an operation displacement sensor SP, and an operation force sensor FP is used. The front and rear wheel master cylinder hydraulic pressure sensors PMf and PMr detect hydraulic pressures (master cylinder hydraulic pressures) Pmf and Pmr in the front and rear wheel hydraulic chambers Rmf and Rmr, respectively. The operation displacement sensor SP detects an operation displacement Sp of the braking operation member BP. The operation force sensor FP detects an operation force Fp applied on the braking operation member BP. That is, the operation amount sensor BA is a general term for a master cylinder hydraulic pressure sensor PM (=PMf and PMr), the operation displacement sensor SP, and the operation force sensor FP. The operation amount Ba is a general term for a master cylinder hydraulic pressure Pm (=Pmf and Pmr), the operation displacement Sp, and the operation force Fp.

The wheel speed sensor VW detects a wheel speed Vw, which is a rotation speed of each wheel WH. A signal of the wheel speed Vw is used for an anti-lock brake control or the like that reduces a locking tendency of the wheel WH. Each wheel speed Vw detected by the wheel speed sensor VW is input to a braking controller ECU. In the braking controller ECU, a vehicle body speed Vx is calculated based on the wheel speed Vw.

### [Braking Control Device SC]

An actuator YU of the braking control device SC is capable of individually controlling (applying) a front wheel braking hydraulic pressure Pwf for generating the front wheel friction braking force Fmf on the front wheel WHf (resulting in the front wheel braking torque Tqf) and a rear wheel braking hydraulic pressure Pwr for generating the rear wheel friction braking force Fmr on the rear wheel WHr (resulting in the rear wheel braking torque Tqr). The actuator YU includes a stroke simulator SS, a simulator valve VS, and a fluid unit HU. Further, the actuator YU is controlled by the braking controller ECU.

The stroke simulator (simply also referred to as a “simulator”) SS is provided to generate the operating force Fp on the braking operation member BP. In other words, operating characteristics of the braking operation member BP (relation of the operation force Fp with respect to the operation displacement Sp) are formed by the simulator SS. For example, the simulator SS is connected to the master cylinder CM (for example, the front wheel hydraulic chamber Rmf). The simulator SS includes a simulator piston and an elastic body (for example, a compression spring) therein. When the braking fluid BF is moved from the hydraulic chamber Rmf into the simulator SS, the simulator piston is pushed by the inflowing braking fluid BF. Since a force is applied to the simulator piston in a direction in which the elastic body blocks an inflow of the braking fluid BF, the operation force Fp corresponding to the operation displacement Sp is generated when the braking operation member BP is operated.

The simulator valve VS is provided between the front wheel hydraulic chamber Rmf and the simulator SS. The simulator valve VS is a normally closed solenoid valve (on and off valve) having an open position and a closed position. When the braking control device SC is started up, the simulator valve VS is opened, and the master cylinder CM and the simulator SS are in a communicated state. When a capacity of the front wheel hydraulic chamber Rmf is sufficiently large as compared with capacities of the front wheel cylinders CWf, the simulator valve VS may be omitted. The simulator SS may be connected to the rear wheel hydraulic chamber Rmr. In this case, the normally closed simulator valve VS is provided between the rear wheel hydraulic chamber Rmr and the simulator SS. Similar to the above, the simulator valve VS may be omitted.

The fluid unit HU includes front and rear wheel separation valves VMf and VMr, the front and rear wheel master cylinder hydraulic pressure sensors PMf and PMr, the fluid pump HP, an electric motor MT, first and second pressure regulating valves UA1 and UA2, front and rear wheel communication valves VRf and VRr, first and second regulated hydraulic pressure sensors PP1 and PP2, front and rear wheel inlet valves VIf and VIr, and front and rear wheel outlet valves VOf and VOr.

The front and rear wheel separation valves VMf and VMr are provided on the front and rear wheel connection paths HSf and HSr, respectively. The front and rear wheel separation valves VMf and VMr are normally opened solenoid valves (on and off valves). The normally opened solenoid valve has an open position and a closed position. When the braking control device SC is started up, the separation valve VM (=VMf and VMr) is closed, and the master cylinder CM and the front and rear wheel cylinders CWf and CWr are disconnected (non-communication state).

The front and rear wheel master cylinder hydraulic pressure sensors PMf and PMr are provided above the front and rear wheel separation valves VMf and VMr so as to detect the hydraulic pressures (front and rear wheel master cylinder hydraulic pressures) Pmf and Pmr in the front and rear wheel hydraulic chambers Rmf and Rmr. The master cylinder hydraulic pressure sensor PM (=PMf and PMr) corresponds to the operation amount sensor BA, and the master cylinder hydraulic pressure Pm (=Pmf and Pmr) corresponds to the operation amount Ba. Since “Pmf=Pmr” is substantially established, any one of the front and rear wheel master cylinder hydraulic pressure sensors PMf and PMr may be omitted.

The fluid pump HP is provided in the recirculation fluid path HK (also referred to as a “recirculation path”). The recirculation path HK is a fluid path provided in parallel with the connection path HS (=HSf and HSr), and connects a suction portion Bs and a discharge portion Bt of the fluid pump HP. The fluid pump HP is driven by an electric motor MT. When the electric motor MT is driven, a recirculation KN of the braking fluid BF (flow of “Bt→Bvr→Bvf→Bw→Bx→Bs→Bt”) is generated in the recirculation path HK as shown by broken line arrows. Herein, the “recirculation” means that the braking fluid BF circulates and returns to an original flow again. A check valve is provided in the recirculation path HK to prevent the braking fluid BF from flowing back.

The recirculation path HK is connected to the master reservoir RV via a reservoir path HV. At an initial stage of driving the fluid pump HP (that is, braking starts when a rotation speed of the electric motor MT increases from “0”), the braking fluid BF is supplied from the master reservoir RV and the recirculation KN is generated.

Two pressure regulating valves (first and second pressure regulating valves) UA1 and UA2 are provided in series in the recirculation path HK. Specifically, in the recirculation path HK, the first pressure regulating valve UA1 is provided downstream of the second pressure regulating valve UA2. The first and second pressure regulating valves UA1 and UA2 are normally opened linear solenoid valves (also referred to as “proportional valves” or “differential pressure valves”) in which a valve opening amount (lift amount) is continuously controlled.

The first pressure regulating valve UA1 throttles the recirculation KN of the braking fluid BF to adjust a hydraulic pressure Pp1 (referred to as a “first regulated hydraulic pressure”) upstream of the first pressure regulating valve UA1. In other words, a difference between hydraulic pressures downstream and upstream of the first pressure regulating valve UA1 is regulated. A hydraulic pressure downstream of the first pressure regulating valve UA1 (a pressure of the braking fluid BF in the suction portion Bs of the fluid pump HP, which is an atmospheric pressure) increases to the first regulated hydraulic pressure Pp1.

Further, the second pressure regulating valve UA2 provided upstream of the first pressure regulating valve UA1 throttles the recirculation KN of the braking fluid BF, regulates a difference between hydraulic pressures downstream and upstream of the second pressure regulating valve UA2, and adjusts a hydraulic pressure Pp2 (referred to as a “second regulated hydraulic pressure”) upstream of the second pressure regulating valve UA2. That is, the first regulated hydraulic pressure Pp1 increases to the second regulated hydraulic pressure Pp2. In other words, it can also be said that a pressure of the braking fluid BF discharged by the fluid pump HP is adjusted to the second regulated hydraulic pressure Pp2 by the normally opened second pressure regulating valve UA2, and then, the second regulated hydraulic pressure Pp2 is reduced and adjusted to the first regulated hydraulic pressure Pp1 by the normally opened first pressure regulating valve UA1. In any case, magnitude relation between the first regulated hydraulic pressure Pp1 and the second regulated hydraulic pressure Pp2 is “Pp1≤Pp2.”

The recirculation path HK and the front wheel connection path HSf are connected by a front wheel communication path HRf. Specifically, the front wheel communication path HRf is a fluid path connecting a lower portion Buf the front wheel separation valve VMf in the front wheel connection path HSf and a portion Bvf between the first pressure regulating valve UA1 and the second pressure regulating valve UA2. A normally closed front wheel communication valve VRf is provided in the front wheel communication path HRf. The front wheel communication valve VRf is a normally closed solenoid valve (on and off valve) having an open position and a closed position. When the braking control device SC is started up, the front wheel communication valve VRf is opened, and the front wheel connection path HSf and the recirculation path HK are in a communicated state. At the time of braking, the braking fluid BF adjusted to the first regulated hydraulic pressure Pp1 is supplied to the front wheel cylinder CWf. Therefore, the front wheel braking hydraulic pressure Pwf is adjusted by the first regulated hydraulic pressure Pp1 (that is, “Pwf=Pp1”).

The recirculation path HK and the rear wheel connection path HSr are connected by a rear wheel communication path HRr. Specifically, the rear wheel communication path HRr is a fluid path connecting a lower portion Bur the rear wheel separation valve VMr in the rear wheel connection path HSr and an upstream portion Bvr of the second pressure regulating valve UA2. A normally closed rear wheel communication valve VRr is provided in the rear wheel communication path HRr. The rear wheel communication valve VRr is a normally closed solenoid valve (on and off valve) having an open position and a closed position. When the braking control device SC is started up, the rear wheel communication valve VRr is opened, and the rear wheel connection path HSr and the recirculation path HK are in a communicated state. That is, since the rear wheel communication valve VRr is set to the open position, the braking fluid BF regulated to the second regulated hydraulic pressure Pp2 is supplied to the rear wheel cylinder CWr during braking. Therefore, the rear wheel braking hydraulic pressure Pwr is adjusted by the second regulated hydraulic pressure Pp2 (that is, “Pwr=Pp2”).

The first and second regulated hydraulic pressure sensors PP1 and PP2 are provided in the front and rear wheel connection paths HSf and HSr so as to detect the first and second regulated hydraulic pressures Pp1 and Pp2. The first and second regulated hydraulic pressure sensors PP1 and PP2 may be provided on the front and rear wheel communication paths HRf and HRr, respectively. The detected first and second regulated hydraulic pressures Pp1 and Pp2 are input to the braking controller ECU.

In the front and rear wheel connection paths HSf and HSr, configurations from the branch portions Bbf and Bbr to lower parts (sides closer to the wheel cylinder CW) are the same. The connection path HS (=HSf and HSr) is provided with an inlet valve VI (=VIf and VIr). A normally opened on and off solenoid valve is used as the inlet valve VI. A portion Bg below the inlet valve VI (that is, between the inlet valve VI and the wheel cylinder CW) is connected to a decompression path HG. The decompression path HG is connected to the suction portion Bs of the fluid pump HP (that is, the master reservoir RV). The decompression path HG is provided with an outlet valve VO (=VOf and VOr). A normally closed on and off solenoid valve is used as the outlet valve VO. An anti-lock brake control and the like are performed by appropriately controlling the inlet valve VI and the outlet valve VO.

The braking controller (“electronic control unit”, also simply referred to as a “controller”) ECU controls the electric motor MT, the solenoid valves UA1 and UA2, the VM, the VR, the VS, and the like that constitute the actuator YU. The braking controller ECU includes an electric circuit board on which a microprocessor MP or the like is mounted and a control algorithm programmed in the microprocessor MP. The braking controller ECU is network-connected to a controller (electronic control unit) of another system such as the drive controller ECD via an in-vehicle communication bus BS. The drive controller ECD acquires (detects or calculates) a rotation speed Ng of the regenerative generator GN. Further, the rotation speed Ng of the regenerative generator GN is input to the braking controller ECU via the communication bus BS. The braking controller ECU calculates a regenerative amount Rg (target value) based on the braking operation amount Ba, the rotation speed Ng, and the like. The regenerative amount Rg is transmitted to the drive controller ECD via the communication bus BS. The drive controller ECD controls the generator GN based on the regeneration amount Rg.

The braking controller ECU controls the electric motor MT and the solenoid valves (VM and the like) based on various signals (Ba, Pp1, Pp2, Vw, Ng, and the like). Specifically, a motor drive signal Mt for controlling the electric motor MT is calculated using the control algorithm in the microprocessor MP. Similarly, solenoid valve drive signals Ua1, Ua2, Vm, Vr, and Vs for controlling the solenoid valves UA1, UA2, VM, VR, and VS are calculated. Then, the electric motor MT and a plurality of solenoid valves are driven based on these drive signals (Mt, Vm, and the like).

### [Processing of Pressure Regulation Control According to First Embodiment]

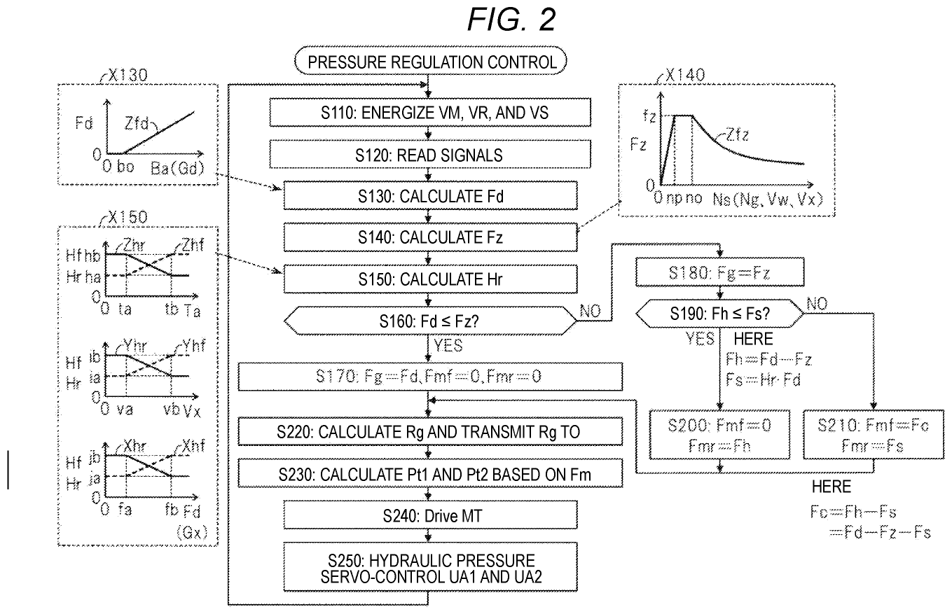

With reference to a control flowchart in FIG. 2 processing of the pressure regulation control including the regenerative cooperative control according to the first embodiment will be described. The “pressure regulation control” is a drive control on the electric motor MT and the first and second pressure regulating valves UA1 and UA2 for regulating the first and second regulated hydraulic pressures Pp1 and Pp2 during braking (for example, when the braking operation member BP is operated, or during automatic braking). An algorithm for the control is programmed in the braking controller ECU.

In step S110, the separation valve VM, the communication valve VR, and the simulator valve VS are energized. For example, the energization is performed when the braking control device SC is started up, the separation valve VM is closed, and the communication valve VR and the simulator valve VS are opened.

In step S120, the braking operation amount Ba, the first and second regulated hydraulic pressures (detected values) Pp1, Pp2, the vehicle body speed Vx, and a required deceleration Gd are read. The braking operation amount Ba (Sp, Fp, Pm, and the like) is detected by the operation amount sensor BA (SP, FP, PM, and the like). The first and second regulated hydraulic pressures Pp1 and Pp2 are detected by the first and second regulated hydraulic pressure sensors PP1 and PP2. The vehicle body speed Vx is calculated based on the wheel speed Vw, and a value thereof is read. When the automatic braking is actuated, the required deceleration Gd is acquired from a driving support controller ECJ (not shown) via the communication bus BS.

In step S130, as shown in a block X130, a required braking force Fd is calculated based on the operation amount Ba (or the required deceleration Gd). The required braking force Fd is a target value of a total braking force Fv acting on the vehicle, and is a braking force obtained by combining “the friction braking force Fm of the braking control device SC” and “the regenerative braking force Fg of the regenerative generator GN”. The required braking force Fd is calculated according to a calculation map Zfd such that the braking force Fd is determined to be “0” when the operation amount Ba is in a range of “0” to a predetermined value bo, and the braking force Fd monotonically increases from “0” as the operation amount Ba increases, when the operation amount Ba is equal to or greater than the predetermined value bo. Similarly, at the time of automatic braking, the required braking force Fd is calculated based on the required deceleration Gd. The required braking force Fd is determined to be “0” when the required deceleration Gd is “0” or more and less than the predetermined value bo. The required braking force Fd is determined to monotonically increase from “0” as the required deceleration Gd increases, when the required deceleration Gd is equal to or greater than the predetermined value bo.

In step S140, as shown in a block X140, a normative value (referred to as a “normative regenerative force”) Fz of the regenerative braking force is calculated based on a value Ns (“rotation speed equivalent value”) equivalent to the rotation speed Ng of the generator GN and a calculation map Zfz. The “rotation speed equivalent value Ns” is a rotation speed of a rotating component which is located in a range from the generator GN to the wheel WH. For example, as the rotation speed equivalent value Ns, at least one of the rotation speed Ng of the generator GN, the wheel speed Vw of the wheel WH (that is, the front wheel WHf) connected to the generator GN, and the vehicle body speed Vx calculated based on the wheel speed Vw is used.

The calculation map Zfz for determining the normative regenerative force Fz is preset as follows. (1) When the rotation speed equivalent value Ns is “0 (stop state)” or more and less than a predetermined value np (referred to as a “second predetermined value”) (0≤Ns<np), the normative regenerative force Fz is increased as the rotation speed equivalent value Ns increases. (2) When the rotation speed equivalent value Ns is equal to or greater than the second predetermined value np and is less than a predetermined value no (referred to as a “first predetermined value”) greater than the second predetermined value np (np≤Ns<no), the rotation speed equivalent value Ns is determined to be limited to a constant value fz. (3) When the rotation speed equivalent value Ns is equal to or greater than the first predetermined value no (no≤Ns), the normative regenerative force Fz is decreased as the rotation speed equivalent value Ns increases.

Herein, the first and second predetermined values no and np are preset as constants according to characteristics of the generator GN, a drive circuit, and the like. The constant value fz is a predetermined value (constant) set in advance.

According to the calculation map Zfz, the normative regenerative force Fz is determined such that as the vehicle decelerates, the normative regenerative force Fz increases as the rotation speed equivalent value Ns decreases, when the rotation speed equivalent value Ns is equal to or greater than the first predetermined value no (in a region of “Ns≥no”), the normative regenerative force Fz is the constant value fz when the rotation speed equivalent value Ns is less than the first predetermined value no and is equal to or greater than the second predetermined value np that is less than the first predetermined value no (in a region of “np≤Ns<no”), and the normative regenerative force Fz decreases as the rotation speed equivalent value Ns decreases, when the rotation speed equivalent value Ns is less than the second predetermined value np (in a region of “Ns<np”). The calculation map Zfz is preset based on the following.

A regenerative amount of the generator GN (resulting in the regenerative braking force Fg) is limited by rating of power transistor (IGBT and the like) of the drive controller ECD and battery charge acceptance. For example, the generator GN is controlled such that the regenerative amount is a predetermined electric power (electrical energy per unit time) When a power is constant, a regenerative braking torque around a wheel shaft generated by the generator GN (resulting in the regenerative braking force Fg) is inversely proportional to the generator rotation speed Ng (that is, the rotation speed equivalent value Ns). When the rotation speed Ng of the generator GN decreases, the regenerative amount decreases and the regenerative braking force Fg decreases. In addition, an upper limit value fz (corresponding to a “constant value”) is set such that the regenerative braking force Fg does not cause an excessive deceleration slip (in an extreme case, a wheel lock) on the wheel WH (that is, the front wheel WHf) connected to the generator GN. For example, the above constant value fz is preset as a value (constant) corresponding to a predetermined deceleration (constant) within a range of “0.15G to 0.3G” of a deceleration Gx of the vehicle. When a friction coefficient μ of a road surface on which the vehicle is traveling is identifiable, the constant value fz can be set as a variable corresponding to the friction coefficient μ. Specifically, the constant value fz is regulated and set such that the greater the friction coefficient μ, the greater the constant value fz. For example, the friction coefficient μ is transmitted from the driving support controller ECJ (not shown) to the braking controller ECU via the communication bus BS.

The normative regenerative force Fz corresponding to the rotation speed equivalent value Ns may be determined (calculated) by the drive controller ECD. In this case, the normative regenerative force Fz is transmitted from the drive controller ECD via the communication bus BS and acquired by the braking controller ECU.

In step S150, as shown in a block X150, a rear wheel ratio Hr (also referred to as a “front-rear ratio”) is calculated based on at least one of a turning state quantity Ta, the vehicle body speed Vx, and the required braking force Fd. Alternatively, the rear wheel ratio Hr may be determined as a preset constant hr. The rear wheel ratio Hr is a value representing a distribution ratio of the braking force between the front and rear wheels. The rear wheel ratio Hr is a distribution ratio (target value) of a rear wheel braking force Fr to a braking force F of the entire vehicle. When the distribution ratio of a front wheel braking force Ff to the braking force F acting on the entire vehicle is set to a front wheel ratio Hf, relation “Hf+Hr=1” is established. For example, the rear wheel ratio Hr is calculated based on the turning state quantity Ta. The turning state quantity Ta is a state quantity representing a degree of turning of the vehicle. At least one of a steering angle Sa, a yaw rate Yr, and a lateral acceleration Gy is used as the turning state quantity Ta. The vehicle is provided with a steering angle sensor SA (not shown), a yaw rate sensor YR (not shown), and a lateral acceleration sensor GY (not shown), these sensors are generally referred to as a “turning state sensor TA”. The steering angle Sa is detected by the steering angle sensor SA, the yaw rate Yr is detected by the yaw rate sensor YR, and the lateral acceleration Gy is detected by the lateral acceleration sensor GY. The rear wheel ratio Hr is calculated so as to decrease as the turning state quantity Ta increases according to a calculation map Zhr. Accordingly, the greater the turning state quantity Ta, the less the rear wheel braking force Fr, and a lateral force of the rear wheel WHr is secured, so that turning stability of the vehicle can be improved. A lower limit value ha and an upper limit value hb are set for the rear wheel ratio Hr.

The rear wheel ratio Hr (front-rear ratio) is calculated based on the vehicle body speed Vx. The rear wheel ratio Hr is calculated so as to decrease as the vehicle body speed Vx increases according to a calculation map Yhr. Accordingly, the higher the vehicle body speed Vx, the less the rear wheel braking force Fr, and the lateral force of the rear wheel WHr is secured, so that directional stability of the vehicle (for example, straightness) can be improved. A lower limit value ia and an upper limit value ib are set for the rear wheel ratio Hr. The rear wheel ratio Hr is calculated based on the required braking force Fd. The rear wheel ratio Hr is calculated so as to decrease as the required braking force Fd increases according to a calculation map Xhr. Accordingly, the greater the required braking force Fd, the less the rear wheel braking force Fr, and the lateral force of the rear wheel WHr is secured, so that similar to the above, the directional stability of the vehicle can be improved. A lower limit value ja and an upper limit value jb are set for the rear wheel ratio Hr. Herein, a front-rear acceleration (deceleration) Gx detected by a front-rear acceleration sensor GX (not shown) provided in the vehicle may be adopted instead of the required braking force Fd. That is, the rear wheel ratio Hr is calculated based on a degree of deceleration of the vehicle such that the greater the degree, the less the rear wheel ratio Hr.

In step S160, “whether the required braking force Fd is equal to or less than the normative regenerative force Fz” is determined based on the required braking force Fd and the normative regenerative force Fz. That is, whether the braking force Fd required by the driver (or automatic braking) is achieved simply by the regenerative braking force Fg is determined. When yes in step S160, that is, “Fd≤Fz”, the process proceeds to step S170. On the other hand, when No in step S160, that is, “Fd>Fz”, the process proceeds to step S180.

In step S170, the regenerative braking force (target value) Fg and the front and rear wheel friction braking forces (target values) Fmf and Fmr are calculated based on the required braking force Fd. Specifically, the target regenerative braking force Fg is determined to match the required braking force Fd, and the target friction braking forces Fmf and Fmr of the front and rear wheels are calculated to be “0” (that is, “Fg=Fd, and Fmf=Fmr=0”). In other words, when the regenerative braking force Fg does not reach the normative regenerative force Fz (when “Fg<Fz”), the required braking force Fd is achieved simply by the regenerative braking force Fg of the generator GN without using the friction braking force Fm generated by the braking hydraulic pressure Pw during vehicle deceleration.

In step S180, the regenerative braking force Fg is calculated based on the normative regenerative force Fz. Specifically, the regenerative braking force Fg is calculated to match the normative regenerative force Fz. That is, when the regenerative braking force Fg reaches the normative regenerative force Fz (when “Fg≥Fz”), “Fg=Fz” is calculated and kinetic energy is effectively regenerated.

In step S190, a rear wheel reference force Fs is calculated based on the required braking force Fd. The rear wheel reference force Fs is a value in which the front-rear ratio (that is, the rear wheel ratio Hr) of the braking force to the required braking force Fd is taken into consideration, and is used as a reference for achieving the rear wheel ratio Hr. Specifically, the required braking force Fd is multiplied by the rear wheel ratio Hr to calculate the rear wheel reference force Fs (that is, “Fs=Hr×Fd”). A complementary braking force Fh is calculated based on the required braking force Fd and the normative regenerative force Fz. The complementary braking force Fh is a braking force that is to be supplemented by frictional braking in order to achieve the required braking force Fd. Specifically, the normative regenerative force Fz is subtracted from the required braking force Fd to calculate the complementary braking force Fh (that is, “Fh=Fd−Fz”). Then, the complementary braking force Fh and the rear wheel reference force Fs are compared, and whether “the complementary braking force Fh is equal to or less than the rear wheel reference force Fs” is determined. When “Fh≤Fs”, the processing proceeds to step 3200, and when “Fh>Fs”, the processing proceeds to step S210.

In step S200, the front wheel friction braking force Fmf is determined to be “0” and the rear wheel friction braking force Fmr is calculated to match the complementary braking force Fh (that is, “Fmf=0, Fmr=Fh”). When the complementary braking force Fh is equal to or less than the rear wheel reference force Fs, the front wheel friction braking force Fmf is not generated on the front wheel WHf, and only the regenerative braking force Fg acts on the front wheel WHf. Then, the friction braking force Fmr is generated on the rear wheel WHr so as to satisfy the required braking force Fd.

On the other hand, in step S210, the rear wheel friction braking force Fmr is calculated to match the rear wheel reference force Fs, and the front wheel friction braking force Fmf is calculated to match a value (referred to as a “front wheel indicating force”) Fc obtained by subtracting the rear wheel reference force Fs from the complementary braking force Fh (that is, “Fmf=Fc=Fh−Fs, and Fmr=Fs”). When the complementary braking force Fh is greater than the rear wheel reference force Fs, the rear wheel friction braking force Fmr is set to the rear wheel reference force Fs in which the rear wheel ratio Hr is taken into consideration, and an amount (=Fc) that is insufficient for the required braking force Fd is determined as the front wheel friction braking force Fmf.

In step S220, the regenerative amount Rg is calculated based on the regenerative braking force Fg. The regenerative amount Rg is a target value of the regenerative amount of the generator GN. The regenerative amount Rg is transmitted from the braking controller ECU to the drive controller ECD via the communication bus BS. In step S230, a target hydraulic pressure Pt (Ptf and Ptr) is calculated based on the target value Fm (Fmf and Fmr) of the friction braking force. That is, the friction braking force Fm is converted into a hydraulic pressure to determine the target hydraulic pressure Pt. The front wheel target hydraulic pressure Ptf is a target value of a hydraulic pressure of the front wheel cylinder CWf corresponding to the first regulated hydraulic pressure Bpl. The rear wheel target hydraulic pressure Ptr is a target value of a hydraulic pressure of the rear wheel cylinder CWr corresponding to the second regulated hydraulic pressure Pp2.

In step S240, the electric motor MT is driven to form the recirculation KN of the braking fluid BF which includes the fluid pump HP. The electric motor MT may be driven (rotated) during braking even if “Ptf=Ptr=0” in order to secure pressure increase responsiveness. Further, in step S250, based on the front and rear wheel target hydraulic pressures Ptf and Ptr, and the first and second regulated hydraulic pressures Pp1 and Pp2 (detected values of the first and second regulated hydraulic pressure sensors PP1 and PP2), the first and second pressure regulating valves UA1 and UA2 are hydraulic pressure servo-controlled such that the first and second regulated hydraulic pressures Pp1 and Pp2 match the front and rear wheel target hydraulic pressures Ptf and Ptr. In the hydraulic pressure servo control, a hydraulic pressure-based feedback control is performed such that the actual values Pp1 and Pp2 approach and match the target values Ptf and Ptr.

### [Transition of Braking Force in First Embodiment]

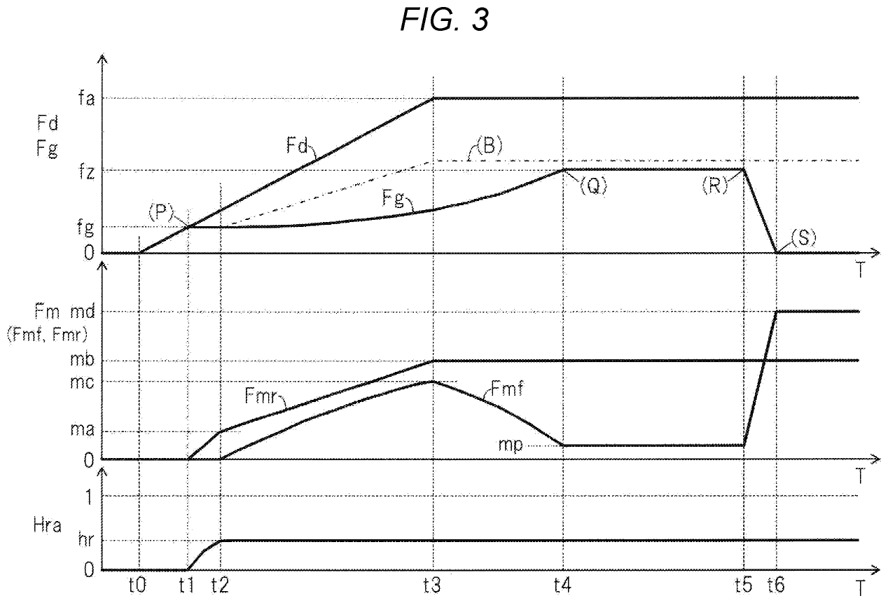

With reference to a time-series line graph in FIG. 3, transition of the friction braking force Fm (=Fmf and Fmr) and the regenerative braking force Fg according to the first embodiment will be described. The generator GN (electric motor for traveling) for energy regeneration is provided on the front wheel WHf, and the regenerative braking force Fg acts on the front wheel WHf in addition to the friction braking force Fmf. On the other hand, the generator GN is not provided on the rear wheel WHr. Therefore, the regenerative braking force does not act on the rear wheel WHr, and only the friction braking force Fmr acts on the rear wheel WHr. In this example, it is assumed that the driver increases an operation amount of the braking operation member BP at a predetermined operation speed (constant value), then keeps the braking operation member BP constant, and the vehicle stops. The rear wheel ratio Hr is set to a certain predetermined constant value (constant) hr which is set in advance (that is, “Hr=hr”). In the time-series line graph, in the required braking force Fd, a regenerative braking force Fg component corresponds to “a part sandwiched between an X-axis and a curve PQRS indicating the regenerative braking force Fg”, and a front wheel friction braking force Fmf component corresponds to “a part sandwiched between a two-dot chain line (B) and the curved PQRS”, and a rear wheel friction braking force Fmr component corresponds to “a part sandwiched between the required braking force Fd and the two-dot chain line (B)”.

At a time point t0, an operation on the braking operation member BP is started, and the braking operation amount Ba increases from “0”. At the time point t0, the pressure regulation control including the regenerative cooperative control is started. As the operation amount Ba increases, the required braking force Fd increases from “0”. Since “Fd≤Fz” during a period from the time point t0 to a time point t1, “Fg=Fd, Fmf=Fmr=0 (processing of S170)” is determined. Therefore, “Ptf=Ptr=0”, and the front and rear wheel braking hydraulic pressures Pwf and Pwr are both set to “0”. Accordingly, the friction braking force Fm (=Fmf and Fmr) is not generated, and the vehicle is decelerated only by the regenerative braking force Fg. That is, when the regenerative braking force Fg of the regenerative generator GN does not reach the normative regenerative force Fz (that is, when “Fg<Fz”), the front and rear wheel friction braking forces Fmf and Fmr are both maintained at “0 (zero)”. At this time, an actual rear wheel ratio Hra is “0”.

The vehicle is decelerated, and at time point t1, the required braking force Fd matches the normative regenerative force Fz. From the time point t1, “Fd>Fz” is established, and thus “Fg=Fz (processing of S180)” is determined. Since the complementary braking force Fh (=Fd-Fz) is less than the rear wheel reference force Fs (=Hr×Fd), “Fmf=0, Fmr=Fh (processing of S200)”. Therefore, the rear wheel target hydraulic pressure Ptr increases while the front wheel target hydraulic pressure Ptf remains at “0.” As a result, the rear wheel braking hydraulic pressure Pwr increases while maintaining a state of “Pwf=0” (that is, the front wheel friction braking force Fmf remains at “0” and the rear wheel friction braking force Fmr increases from “0”). In other words, when the regenerative braking force Fg reaches the normative regenerative force Fz, the rear wheel friction braking force Fmr increases from “0” before the front wheel friction braking force Fmf increases from “0”, and an amount of increase in the required braking force Fd is supplemented only by the rear wheel friction braking force Fmr. Therefore, an actual rear wheel ratio Hra changes from “0” toward a set value (constant) hr.

At a time point t2, the complementary braking force Fh matches the rear wheel reference force Fs (reference value according to the rear wheel ratio Hr). Since “Fh>Fs” from the time point t2, “Fg=Fz, Fmf=Fc=Fh−Fs, Fmr=Fs (processing of S180 and S210)”. Therefore, the target rear wheel hydraulic pressure Ptr increases and the target front wheel hydraulic pressure Ptf increases from “0”, and as a result, the front and rear wheel braking hydraulic pressures Pwf and Pwr are both increased. The front wheel friction braking force Fmf starts to increase, and the rear wheel friction braking force Fmr is continuously increased while an increasing gradient thereof decreases from the state of “Fh≤Fs”. When the rotation speed equivalent value Ns (for example, the rotation speed Ng of the generator GN, the wheel speed Vw, and the vehicle body speed Vx) is reduced, the normative regenerative force Fz increases, and the regenerative braking force Fg increases accordingly (see characteristics Zfz in the block X140). The front wheel braking hydraulic pressure Pwf (resulting in the front wheel friction braking force Fmf) is determined based on the front wheel indicating force Fc, and the rear wheel braking hydraulic pressure Pwr (resulting in the rear wheel friction braking force Fmr) is determined based on the rear wheel reference force Fs. Accordingly, the rear wheel ratio Hra (including the regenerative braking force Fg) can be suitably maintained at a target set value hr.

At a time point t3, the braking operation amount Ba is maintained constant, and the required braking force Fd is a constant value fa. Even if the required braking force Fd is constant, the rotation speed equivalent value Ns increases as the vehicle decelerates. Therefore, the normative regenerative force Fz increases, and the regenerative braking force Fg increases. From the time point t3, a change in the regenerative braking force Fg is compensated, and the front wheel friction braking force Fmf is reduced in order to maintain the rear wheel ratio Hra at a target value hr. At this time, the rear wheel friction braking force Fmr is maintained at a value mb (=Fs). At a time point t4, the rotation speed equivalent value Ns is the first predetermined value no (preset value), and the regenerative braking force Fg reaches the constant value fz (for example, an upper limit value which is a predetermined constant set in advance). From the time point t4, since the required braking force Fd and the regenerative braking force Fg are constant, the front wheel friction braking force Fmf is maintained at a value mp while the rear wheel friction braking force Fmr is maintained at the value mb.

At a time point t5, the rotation speed equivalent value Ns reaches the second predetermined value np (preset value) which is less than the first predetermined value no, and the normative regenerative force Fz decreases. That is, at the time point t5, a replacement operation between regenerative braking and friction braking is started. At this time, the rear wheel friction braking force Fmr is constant, and an amount of decrease in the regenerative braking force Fg is compensated by the front wheel friction braking force Fmf. After the rear wheel friction braking force Fmr reaches the rear wheel reference force Fs (=mb), the rear wheel friction braking force Fmr is kept constant, fluctuation of the regenerative braking force Fg is regulated by the front wheel friction braking force Fmf, and thus the rear wheel ratio (actual value) Hra including the regenerative braking force Fg can be maintained at the target value hr.

When the required braking force Fd is achievable simply by the regenerative braking force Fg (Fd≤Fz), the front and rear wheel friction braking forces Fmf and Fmr are both set to “0”, and the friction braking force Fm is not generated. Therefore, the generator GN may effectively regenerate the kinetic energy of the vehicle into the electrical energy. When the required braking force Fd is not achievable simply by the regenerative braking force Fg, the rear wheel friction braking force Fmr increases to a value corresponding to the rear wheel reference force Fs in which the front-rear distribution ratio of the braking force is taken into consideration while the front wheel friction braking force Fmf is maintained at “0”. Therefore, a desired distribution ratio hr is achieved. After the target distribution ratio hr is achieved, the front wheel friction braking force Fmf increases, and the rear wheel friction braking force Fmr increases while the increasing gradient of the rear wheel friction braking force Fmr decreases. Therefore, the target ratio hr can be preferably maintained.

### [Braking Control Device for Vehicle According to Second Embodiment]

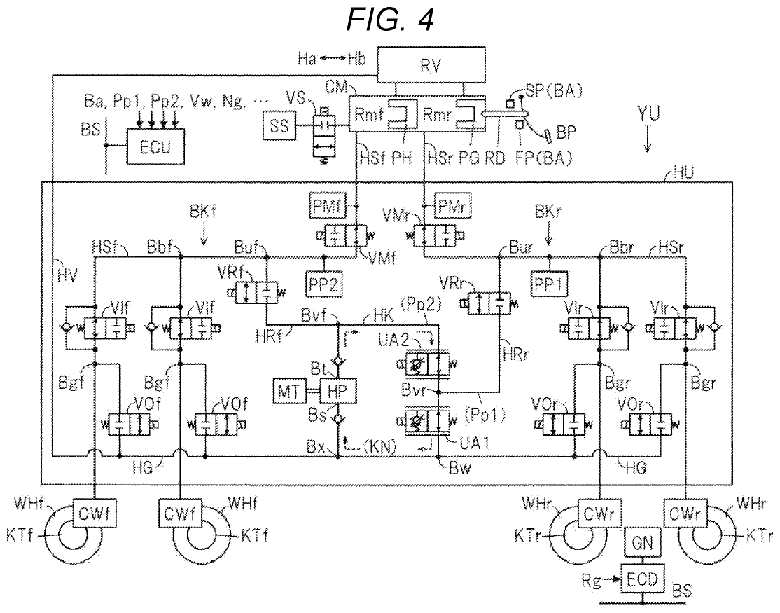

A braking control device SC according to a second embodiment of the invention will be described with reference to an overall configuration in FIG. 4. The braking control device SC according to the first embodiment is applied to an electric vehicle provided with the regenerative generator GN on the front wheel WHf, and the braking control device SC according to the second embodiment is applied to an electric vehicle provided with the regenerative generator GN on the rear wheel WHr. Hereinafter, differences from the braking control device SC according to the first embodiment will be described.

As described above, components and the like denoted by the same reference numerals have the same functions. Subscripts “f” and “r” at the ends of reference numerals indicate that the “f” is related to the front wheels WHf and the “r” is related to the rear wheels WHr. The subscripts “f” and “r” may be omitted. When the subscripts “f” and “r” are omitted, each reference numeral indicates a generic term. In the connection path HS, a side away from the wheel cylinder CW is referred to as an “upper portion”, and a side close to the wheel cylinder CW is referred to as a “lower portion”. In the recirculation path HK, a side of the fluid pump HP close to the discharge portion Bt is referred to as an “upstream (upstream portion)”, and a side away from the discharge portion Bt is referred to as a “downstream (downstream portion)”.

Also in the braking control device SC according to the second embodiment, a front-rear type braking system (front and rear wheel braking systems BKf and BKr) is used as the two-system braking system. Differences from the braking control device SC according to the first embodiment will be described below.

The front wheel communication path HRf connects the portion Bvf between the discharge portion Bt of the fluid pump HP in the recirculation path HK and the second pressure regulating valve UA2 and the lower portion Buf the front wheel separation valve VMf in the front wheel connection path HSf. Therefore, the braking fluid BF adjusted to the second regulated hydraulic pressure Pp2 is supplied to the front wheel cylinder CWf (that is, “Pwf=Pp2”). The rear wheel communication path HRr connects the portion Bvr between the first pressure regulating valve UA1 and the second pressure regulating valve UA2 in the recirculation path HK and the lower portion Bur the rear wheel separation valve VMr in the rear wheel connection path HSr. Therefore, the braking fluid BF adjusted to the first regulated hydraulic pressure Pp1 is supplied to the rear wheel cylinder CWr (that is, “Pwr=Pp1”). That is, the front wheel braking hydraulic pressures Pwf (=Pp2) are individually regulated in a range of the rear wheel braking hydraulic pressure Pwr (=Pp1) or higher. The first regulated hydraulic pressure sensor PP1 is provided in the rear wheel connection path HSr so as to detect the first regulated hydraulic pressure Pp1. The first regulated hydraulic pressure sensor PP1 may be provided in the rear wheel communication path HRr. The second regulated hydraulic pressure sensor PP2 is provided in the front wheel connection path HSf so as to detect the second regulated hydraulic pressure Pp2. The second regulated hydraulic pressure sensor PP2 may be provided in the front wheel communication path HRf. Differences from the first embodiment have been described above.

### [Processing Example of Pressure Regulation Control in Second Embodiment]

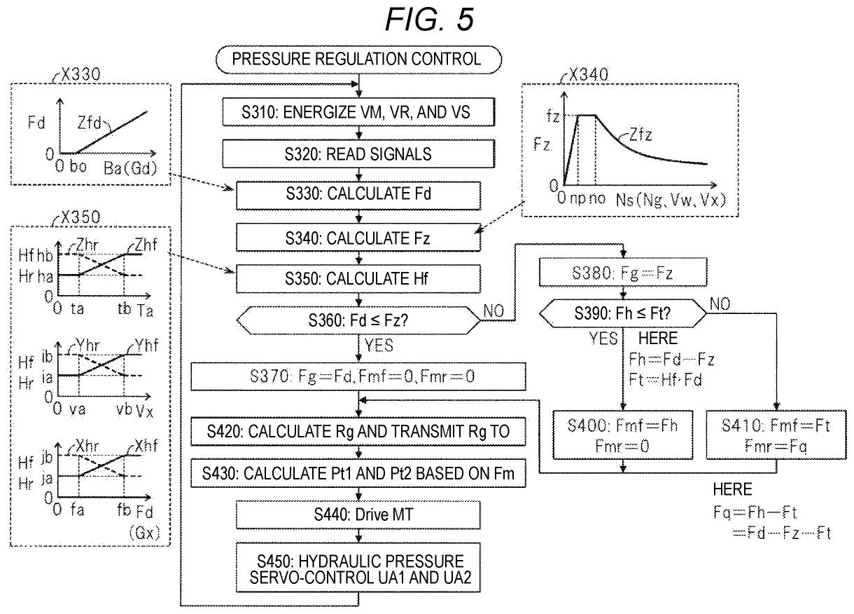

With reference to a control flowchart in FIG. 5, processing of the pressure regulation control according to the second embodiment will be described. In the first processing example, the regulation control is performed based on the rear wheel reference force Fs. However, in the second processing example, the regulation control is performed based on the front wheel reference force Ft.

In steps S310 to S340, the same processing as the processing of steps S110 to S140 is performed.

In step S310, the separation valve VM, the communication valve VR, and the simulator valve VS are energized. In step S320, various signals (Ba, Pp1, Pp2, Gd, Vx, Ng, and the like) are read. In step S330, the required braking force Fd is calculated based on the calculation map Zfd shown in a block X330 (the same as the block X130). The required braking force Fd is a target value of the total braking force Fv to be applied to the vehicle in response to an operation on the braking operation member BP or automatic braking. In step S340, the normative regenerative force Fz is calculated based on the calculation map Zfz shown in a block X340 (the same as the block X140). The normative regenerative force Fz is a standard value of the regenerative braking force Fg generated by the generator GN. The normative regenerative force Fz may be calculated by the drive controller ECD and acquired by the braking controller ECU via the communication bus BS.

In step S350, as shown in a block X350 (the same as the block X150), the front wheel ratio Hf (corresponding to a “front-rear ratio”) is calculated based on at least one of the turning state quantity Ta, the vehicle body speed Vx, and the required braking force Fd. Alternatively, the front wheel ratio Hf is determined as a preset constant hf. The front wheel ratio Hf is a value (target value) representing a distribution ratio of a braking force between front and rear wheels. Relation between the front and rear wheel distribution ratios Hf and Hr is “Hf+Hr=1”. For example, the front wheel ratio Hf is calculated based on the turning state quantity Ta (at least one of the steering angle Sa, the yaw rate Yr, and the lateral acceleration Gy). The front wheel ratio Hf is calculated so as to increase as the turning state quantity Ta increases according to a calculation map Zhf. The greater the turning state quantity Ta, the more reliably a lateral force of the rear wheel WHr is secured, so that turning stability of the vehicle may be improved. A lower limit value ha and an upper limit value hb are set for the front wheel ratio Hf.

The front wheel ratio (front-rear ratio) Hf is calculated based on the vehicle body speed Vx. The front wheel ratio Hf is calculated so as to increase as the vehicle body speed Vx increases according to a calculation map Yhf. The higher the vehicle body speed Vx, the more reliably the lateral force of the rear wheel WHr is secured, so that directional stability of the vehicle (for example, straightness) can be improved. A lower limit value ia and an upper limit value ib are set for the front wheel ratio Hf. The front wheel ratio Hf is calculated based on the required braking force Fd. The front wheel ratio Hf is calculated so as to increase as the required braking force Fd increases according to a calculation map Xhf. The greater the required braking force Fd, the more reliably the lateral force of the rear wheel WHr is secured, so that the directional stability of the vehicle can be improved. A lower limit value ja and an upper limit value jb are set for the front wheel ratio Hf. A front-rear acceleration (deceleration) Gx may be used instead of the required braking force Fd. That is, the front wheel ratio Hf is calculated based on a degree of deceleration of the vehicle such that the greater the degree, the greater the front wheel ratio Hf.

In steps S360 to S380, the same processing as the processing of the steps S160 to S180 is performed.

In step S360, “whether the required braking force Fd is equal to or less than the normative regenerative force Fz” is determined based on the required braking force Fd and the normative regenerative force Fz. When “Fd≤Fz”, the processing proceeds to step S370. On the other hand, when “Fd>Fz”, the process proceeds to step S380. In step S370, the regenerative braking force (target value) Fg and the front and rear wheel friction braking forces (target values) Fmf and Fmr are calculated based on the required braking force Fd. Specifically, “Fg=Fd, Fmf=Fmr=0”. That is, when the regenerative braking force Fg does not reach the normative regenerative force Fz (when “Fg<Fz”), the required braking force Fd is achieved simply by the regenerative braking force Fg without using the friction braking force Fm during vehicle deceleration. In step S380, the regenerative braking force Fg is calculated based on the normative regenerative force Fz. Specifically, “Fg=Fz”.

In step S390, the front wheel reference force Ft is calculated based on the required braking force Fd. The front wheel reference force Ft is a value in which a front-rear ratio of a braking force (that is, the front wheel ratio Hf) with respect to the required braking force Fd is taken into consideration, and is used as a reference when the front wheel ratio Hf is achieved. For example, the front wheel reference force Ft is calculated by multiplying the required braking force Fd by the front wheel ratio Hf (that is, “Ft=Hf×Fd”). The complementary braking force Fh is calculated based on the required braking force Fd and the normative regenerative force Fz. The complementary braking force Fh is a braking force that is to be supplemented by frictional braking in order to achieve the required braking force Fd. Specifically, the normative regenerative force Fz is subtracted from the required braking force Fd to calculate the complementary braking force Fh (that is, “Fh=Fd−Fz”). Then, the complementary braking force Fh and the front wheel reference force Ft are compared, and “whether the complementary braking force Fh is equal to or less than the front wheel reference force Ft” is determined. When “Fh≤Ft”, the processing proceeds to step S400, and when “Fh>Ft”, the processing proceeds to step S410.

In step S400, the rear wheel friction braking force Fmr is determined to be “0”, and the front wheel friction braking force Fmf is calculated to match the complementary braking force Fh (that is, “Fmf=Fh, Fmr=0”). When the complementary braking force Fh is equal to or less than the front wheel reference force Ft, the rear wheel friction braking force Fmr is not generated on the rear wheel WHr, and only the regenerative braking force Fg acts on the rear wheel WHr. On the other hand, in step S410, the front wheel friction braking force Fmf is calculated to match the front wheel reference force Ft, and the rear wheel friction braking force Fmr is calculated to match a value (referred to as a “rear wheel indicating force”) Fq obtained by subtracting the front wheel reference force Ft from the complementary braking force Fh (that is, “Fmf=Ft, Fmr=Fq=Fh−Ft”). When the complementary braking force Fh is greater than the front wheel reference force Ft, the front wheel friction braking force Fmf is set to the front wheel reference force Ft in which the front wheel ratio Hf is taken into consideration, and an amount (=Fq) that is insufficient for the required braking force Fd is determined as the rear wheel friction braking force Fmr.

In step S420, the regenerative amount Rg (target value) is calculated based on the regenerative braking force Fg and transmitted to the drive controller ECD via the communication bus BS. In step S430, the target hydraulic pressures Ptf and Ptr are calculated based on the front and rear wheel target values Fmf and Fmr of the friction braking force. The front wheel target hydraulic pressure Ptf is a target value of a hydraulic pressure of the front wheel cylinder CWf corresponding to the second regulated hydraulic pressure Pp2. The rear wheel target hydraulic pressure Ptr is a target value of a hydraulic pressure of the rear wheel cylinder CWr corresponding to the first regulated hydraulic pressure Pp1.

In step S440, the electric motor MT is driven to form the recirculation KN of the braking fluid BF which includes the fluid pump HP. In step S450, based on the rear and front wheel target hydraulic pressures Ptr and Ptf, and the first and second regulated hydraulic pressures Pp1 and Pp2 (detected values), a hydraulic servo control (a hydraulic pressure feedback control) of the first and second pressure regulating valves UA1 and UA2 is performed such that the first and second regulated hydraulic pressures Pp1 and Pp2 match the rear and front wheel target hydraulic pressures Ptr and Ptf.

### [Transition of Braking Force in Second Embodiment]

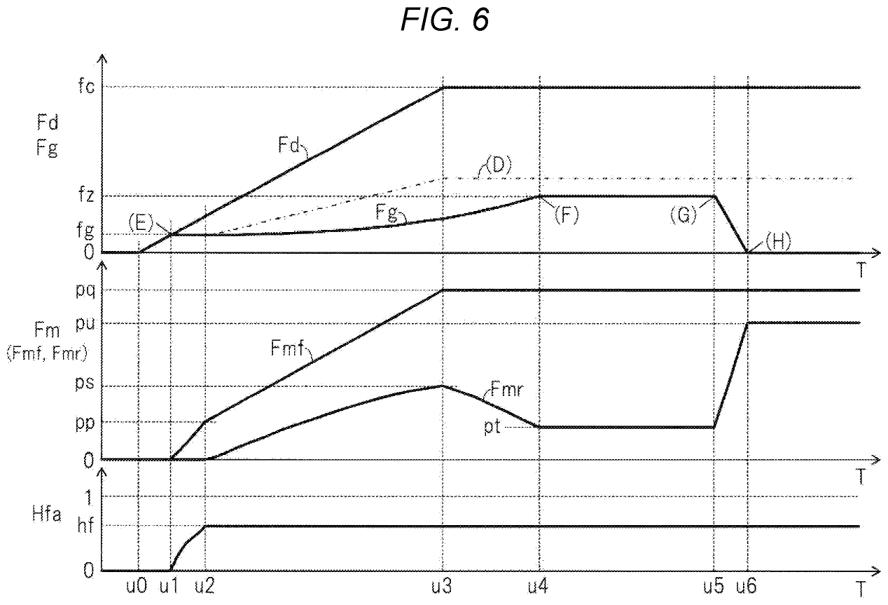

With reference to a time-series line graph in FIG. 6, transition of the braking forces Fd, Fg, and Fm according to the second embodiment will be described. In the second processing example, the regenerative generator GN is provided on the rear wheel WHr, and the regenerative braking force Fg acts on the rear wheel WHr in addition to the friction braking force Fmr. Since the generator GN is not provided on the front wheel WHf, only the friction braking force Fmf acts on the front wheel WHf. Similar to the first embodiment, it is assumed that a driver operates the braking operation member BP at a constant operation speed, then keeps the braking operation member BP constant, and the vehicle stops. The front wheel ratio (front-rear ratio) Hf is set to a certain predetermined constant value (constant) hf which is set in advance (that is, “Hf=hf”). In the line graph, a regenerative braking force Fg component corresponds to “a part sandwiched between an X-axis and a curve EFGH of the regenerative braking force Fg”, a rear wheel friction braking force Fmr component corresponds to “a part sandwiched between a two-dot chain line (D) and the curve EFGH”, and a front wheel friction braking force Fmf component corresponds to “a part sandwiched between the required braking force Fd and the two-dot chain line (D)”.

At a time point u0, the operation on the braking operation member BP is started, the operation amount Ba increases from “0”, and the required braking force Fd starts to increase. At an initial stage of braking (between the time point u0 and a time point u1), since “Fd≤Fz”, “Fg=Fd, Fmf=Fmr=0 (processing of S370)” is determined, and the front and rear wheel braking hydraulic pressures Pwf and Pwr (that is, front and rear wheel friction braking forces Fmf and Fmr) are both set to “0”. That is, the friction braking force Fm is not generated, and the vehicle is decelerated only by the regenerative braking force Fg. At this time, an actual front wheel ratio Hfa is “0” and the actual rear wheel ratio Hra is “1”.

The vehicle is decelerated and relation “Fd=Fz” is established at the time point u1, then “Fd>Fz” is established, and thus “Fg=Fz (processing of S380)” is determined. Since “Fh≤Ft (=Hf×Fd)”, “Fmf=Fh, Fmr=0 (processing of S400)”. Therefore, the front wheel target hydraulic pressure Ptf increases while the rear wheel target hydraulic pressure Ptr remains at “0”. When the regenerative braking force Fg reaches the normative regenerative force Fz, the front wheel friction braking force Fmf increases from “0” before the rear wheel friction braking force Fmr increases from “0”. Since an amount of increase in the required braking force Fd is supplemented only by the front wheel friction braking force Fmf, the actual front wheel ratio Hfa including the regenerative braking force Fg increases (regulated) from “0” toward the set value (constant) hf.

At a time point u2, “Fh=Ft” is established, then “Fh>Ft” is established, and thus “Fg=Fz, Fmf=Ft, Fmr=Fq (processing of S380 and S410)”. Therefore, as the front wheel target hydraulic pressure Ptf continues to increase, the rear wheel target hydraulic pressure Ptr starts to increase. As a result, the rear wheel friction braking force Fmr increases from “0” and an increase gradient of the front wheel friction braking force Fmf is reduced as compared with the case of “Fh Ft”, and the front wheel friction braking force Fmf continues to increase. Therefore, the front wheel ratio Hfa can be reliably maintained at a target set ratio hf.

At a time point u3, the braking operation amount Ba is maintained constant, and the required braking force Fd is a constant value fc. Even if the required braking force Fd is constant, the normative regenerative force Fz increases and the regenerative braking force Fg increases as the vehicle decelerates (that is, the rotation speed equivalent value Ns decreases). From the time point u3, a change in the regenerative braking force Fg is compensated, and the rear wheel friction braking force Fmr is adjusted to decrease in order to maintain the front wheel ratio Hfa at the target value hf. At this time, the front wheel friction braking force Fmf is maintained at a value mb (=Ft). At a time point u4, the rotation speed equivalent value Ns is the first predetermined value no, and the regenerative braking force Fg (=Fz) reaches the upper limit value fz. From the time point u4, the required braking force Fd and the regenerative braking force Fg are constant, so that the rear wheel friction braking force Fmr is maintained at a value pt while the front wheel friction braking force Fmf is maintained at a value pq.

At a time point u5, the rotation speed equivalent value Ns reaches the second predetermined value np (<no), and the normative regenerative force Fz decreases. That is, at the time point u5, a replacement operation between the regenerative braking and the friction braking is started. At this time, the front wheel friction braking force Fmf is set to be constant, and an amount of decrease in the regenerative braking force Fg is compensated by the rear wheel friction braking force Fmr. After the rear wheel friction braking force Fmr reaches the front wheel reference force Ft (=pu), the front wheel friction braking force Fmf is also kept constant. Since fluctuation of the regenerative braking force Fg is regulated by the rear wheel friction braking force Fmr, the front wheel ratio Hfa can be maintained at the target ratio hf.

Similar to the first embodiment, the second embodiment achieves the following effects. When the required braking force Fd is achievable simply by the regenerative braking force Fg, the front and rear wheel friction braking forces Fmf and Fmr are both set to “0”, and the friction braking force Fm is not generated, so that sufficient energy regeneration performed by the generator GN is secured. When the required braking force Fd is not achievable simply by the regenerative braking force Fg, the front wheel friction braking force Fmf increases to a value corresponding to the front wheel reference force Ft (a front wheel braking force in which the braking force distribution ratio hf is taken into consideration) while the rear wheel friction braking force Fmr is maintained at “0”. Therefore, a desired front-rear ratio hf is achieved. After the ratio hf is achieved, the rear wheel friction braking force Fmr increases, and the front wheel friction braking force Fmf is continuously increased while the increasing gradient of the front wheel friction braking force Fmf is reduced. Therefore, the desired distribution ratio hf can be preferably maintained.

### Overview of Embodiments

The embodiments of the braking control device SC according to the invention will be overviewed.

The braking control device SC according to the first embodiment is provided in a vehicle including the regenerative generator GN on the front wheel WHf. Therefore, the regenerative braking force Fg of the regenerative generator GN is generated on the front wheel WHf. The braking control device SC includes “the actuator YU which is capable of individually generating the front wheel friction braking force Fmf on the front wheel WHf and the rear wheel friction braking force Fmr on the rear wheel WHr of the vehicle” and “the braking controller ECU that controls the actuator YU”. Then, the braking controller ECU regulates the front and rear wheel friction braking forces Fmf and Fmr based on the normative regenerative force Fz corresponding to the rotation speed equivalent value Ns equivalent to the rotation speed Ng of the regenerative generator GN. Herein, “the friction braking forces Fmf and Fmr” are braking forces generated by pressing a friction member (for example, a brake pad) against the rotating members (for example, brake discs) KT fixed to the wheels WH. The normative regenerative force Fz (in regenerative cooperative control, a standard value of the regenerative braking force Fg determined according to the rotation speed equivalent value Ns) may be calculated by the braking controller ECU, or may be calculated by the drive controller ECD and acquired by the braking controller ECU.

The regenerative braking force Fg is limited by rating of a power transistor that drives the generator GN, battery charge acceptance, and the like. When a rotation speed of the generator GN decreases, the regenerative braking force Fg decreases. That is, the regenerative braking force Fg changes according to an operating state of the generator GN. In the braking control device SC, since the front and rear wheel friction braking forces Fmf and Fmr are regulated according to the operating state (that is, the rotation speed equivalent value Ns) of the generator GN, energy regeneration can be appropriately performed. Herein, the rotation speed equivalent value Ns is a rotation speed of the rotating member which is located in a range from the generator GN to the front wheel WHf, and corresponds to at least one of the rotation speed Ng of the generator GN, the wheel speed Vw, and the vehicle body speed Vx.

In the braking control device SC, when the regenerative braking force Fg does not reach the normative regenerative force Fz, both the front and rear wheel friction braking forces Fmf and Fmr are set to “0 (zero)” by the braking controller ECU. That is, the vehicle is decelerated only by the regenerative braking force Fg. On the other hand, when the regenerative braking force Fg reaches the normative regenerative force Fz, the rear wheel friction braking force Fmr increases from “0” before the front wheel friction braking force Fmf increases from “0”. That is, when “Fg<Fz”, since the front wheel friction braking force Fmf and the rear wheel friction braking force Fmr are both set to “0”, sufficient energy can be regenerated. Further, when “Fg Fz”, since the rear wheel friction braking force Fmr starts to increase before the front wheel friction braking force Fmf starts to increase, a desired front-rear distribution ratio Hr of the braking force is achieved. In addition, after the desired distribution ratio Hr is achieved, the front wheel friction braking force Fmf increases based on the complementary braking force Fh and the rear wheel reference force Fs, and the rear wheel friction braking force Fmr increases based on the rear wheel reference force Fs, and thus the distribution ratio Hf can be reliably maintained. Since a front-rear distribution of the braking force Fv acting on an entire vehicle including the friction braking force Fm and the regenerative braking force Fg is appropriately regulated, steering stability of the vehicle can be secured.

The braking control device SC according to the second embodiment is provided in a vehicle including the regenerative generator GN on the rear wheel WHr. Therefore, the regenerative braking force Fg of the regenerative generator GN is generated on the rear wheel WHr. Similar to the first embodiment, the braking control device SC includes “the actuator YU capable of individually generating the front wheel friction braking force Fmf on the front wheel WHf and the rear wheel friction braking force Fmr on the rear wheel WHr”, and “the braking controller ECU that controls the actuator YU”. The braking controller ECU regulates the front and rear wheel friction braking forces Fmf and Fmr based on the normative regenerative force Fz corresponding to the rotation speed equivalent value Ns equivalent to the rotation speed Ng of the regenerative generator GN. Since the front and rear wheel friction braking forces Fmf and Fmr are regulated according to the operating state (that is, the rotation speed equivalent value Ns) of the generator GN, the energy regeneration can be appropriately performed. Similar to the above, the normative regenerative force Fz may be calculated by the braking controller ECU based on the rotation speed equivalent value Ns, or may be calculated by the drive controller ECD and acquired by the braking controller ECU. In any case, the normative regenerative force Fz is a value corresponding to the rotation speed equivalent value Ns, and is a reference value of the regenerative braking force Fg in the regenerative cooperative control.

In the braking control device SC, when the regenerative braking force Fg does not reach the normative regenerative force Fz, both the front and rear wheel friction braking forces Fmf and Fmr are set to “0” by the braking controller ECU, and when the regenerative braking force Fg reaches the normative regenerative force Fz, the front wheel friction braking force Fmf increases from “0” before the rear wheel friction braking force Fmr increases from “0”. That is, when “Fg<Fz”, since the front wheel friction braking force Fmf and the rear wheel friction braking force Fmr are both set to “0”, energy regenerative amount is sufficiently secured. Further, when “Fg≥Fz”, since the front wheel friction braking force Fmf starts to increase before the rear wheel friction braking force Fmr starts to increase, a desired front-rear distribution ratio Hf of the braking force can be achieved. In addition, after the desired distribution ratio Hf is achieved, the front wheel friction braking force Fmf increases based on the front wheel reference force Ft, and the rear wheel friction braking force Fmr increases based on the complementary braking force Fh and the front wheel reference force Ft, so that the distribution ratio Hf can be reliably maintained. Similar to the first embodiment, since a front-rear distribution of the braking force Fv (=friction braking force Fm+regenerative braking force Fg) acting on the vehicle is optimized, steering stability of the vehicle can be secured.

When the rotation speed equivalent value Ns is equal to or greater than the first predetermined value no, the normative regenerative force Fz is determined to increase as the rotation speed equivalent value Ns decreases. When the rotation speed equivalent value Ns is less than the first predetermined value no and is equal to or greater than the second predetermined value np that is less than the first predetermined value no, the normative regenerative force Fz is determined to be a constant value fz. When the rotation speed equivalent value Ns is less than the second predetermined value np, the normative regenerative force Fz is determined to decrease as the rotation speed equivalent value Ns decreases. Herein, the constant value fz is set to a predetermined value such that the regenerative braking force Fg does not cause an excessive deceleration slip on the wheel WH (front wheel WHf or rear wheel WHr) provided with the generator GN. For example, the constant value fz is set as a value (constant) in which a predetermined deceleration within a range of “0.15G to 0.3G” of the deceleration Gx of the vehicle is converted into a dimension of the braking force.

### Other Embodiments

Hereinafter, the other embodiments will be described. In other embodiments, the same effect (achievement of efficient energy regeneration and improvement of steering stability based on obtaining desired front-rear distribution ratios Hf and Hr) as described above is obtained.

In the above embodiments, the rear wheel reference force Fs is calculated based on the rear wheel ratio Hr, and the front wheel reference force Ft is calculated based on the front wheel ratio Hf. Since relation of “Hf+Hr=1” is established, the rear wheel reference force Fs may be calculated based on the front wheel ratio Hf, and the front wheel reference force Ft may be calculated based on the rear wheel ratio Hr. Specifically, the required braking force Fd is multiplied by “1−Hf” to calculate the rear wheel reference force Fs. The required braking force Fd is multiplied by “1−Hr” to calculate the front wheel reference force Ft. Therefore, the rear wheel reference force Fs and the front wheel reference force Ft are calculated based on the distribution ratios Hf and Hr (front-rear ratio of the braking force acting on the vehicle).

In the above embodiments, the recirculation KN of the braking fluid BF is generated by the electric motor MT, and the first and second pressure regulating valves UA1 and UA2 throttle the recirculation KN to regulate the front and rear wheel braking torques Tqf and Tqr. As a result, the front and rear wheel friction braking forces Fmf and Fmr are adjusted. Instead, the braking control device SC may be used in which the electric motor MT directly regulates the hydraulic pressures (braking hydraulic pressures) Pwf and Pwr of the braking fluid BF in the front and rear wheel cylinders CWf and CWr, and controls the front and rear wheel friction braking forces Fmf and Fmr (for example, see JP-A-2017-193219). That is, a known hydraulic braking control device may be used as the braking control device SC. A known electric braking control device SC in which the braking fluid BF is not used may be used (for example, see JP-A-2011-173521). In the device, rotation of the electric motor is converted into linear power by a screw mechanism or the like, and a friction member is pressed against the rotating member KT. In this case, instead of the braking hydraulic pressure Pw, the front and rear wheel braking torques Tqf and Tqr are generated by a pressing force of the friction member against the rotating member KT, which is generated by using an electric motor as a power source. A configuration in which a hydraulic braking control device and an electric braking control device are combined may be used (for example, see JP-A-2014-51197).

1. A braking control device for a vehicle in which a regenerative braking force is generated on a front wheel of the vehicle by a regenerative generator provided on the front wheel, the device comprising:
an actuator configured to individually generate a front wheel friction braking force on the front wheel and a rear wheel friction braking force on a rear wheel of the vehicle; and
a controller configured to control the actuator, wherein
the controller is configured to regulate the front and rear wheel friction braking forces based on a normative regenerative force corresponding to a rotation speed equivalent value equivalent to a rotation speed of the regenerative generator.

2. The braking control device for a vehicle according to claim 1, wherein
the controller is configured to:
when the regenerative braking force does not reach the normative regenerative force, set both the front and rear wheel friction braking forces to zero, and
when the regenerative braking force reaches the normative regenerative force, increase the rear wheel friction braking force from zero before increasing the front wheel friction braking force from zero.

3. A braking control device for a vehicle in which a regenerative braking force is generated on a rear wheel of the vehicle by a regenerative generator provided on the rear wheel, the device comprising:
an actuator configured to individually generate a front wheel friction braking force on a front wheel of the vehicle and a rear wheel friction braking force on the rear wheel; and
a controller configured to control the actuator, wherein
the controller is configured to regulate the front and rear wheel friction braking forces based on a normative regenerative force corresponding to a rotation speed equivalent value equivalent to a rotation speed of the regenerative generator.

4. The braking control device for a vehicle according to claim 3, wherein
the controller is configured to:
when the regenerative braking force does not reach the normative regenerative force, set both the front and rear wheel friction braking forces to zero, and
when the regenerative braking force reaches the normative regenerative force, increase the front wheel friction braking force from zero before increasing the rear wheel friction braking force from zero.

5. The braking control device for a vehicle according to claim 1, wherein
the normative regenerative force is determined such that:
when the rotation speed equivalent value is equal to or greater than a first predetermined value, the normative regenerative force increases as the rotation speed equivalent value decreases,
when the rotation speed equivalent value is less than the first predetermined value and is equal to or greater than a second predetermined value less than the first predetermined value, the normative regenerative force is a constant value, and
when the rotation speed equivalent value is less than the second predetermined value, the normative regenerative force decreases as the rotation speed equivalent value decreases.

6. The braking control device for a vehicle according to claim 2, wherein
the normative regenerative force is determined such that:
when the rotation speed equivalent value is equal to or greater than a first predetermined value, the normative regenerative force increases as the rotation speed equivalent value decreases,
when the rotation speed equivalent value is less than the first predetermined value and is equal to or greater than a second predetermined value less than the first predetermined value, the normative regenerative force is a constant value, and
when the rotation speed equivalent value is less than the second predetermined value, the normative regenerative force decreases as the rotation speed equivalent value decreases.

7. The braking control device for a vehicle according to claim 3, wherein
the normative regenerative force is determined such that:
when the rotation speed equivalent value is equal to or greater than a first predetermined value, the normative regenerative force increases as the rotation speed equivalent value decreases,
when the rotation speed equivalent value is less than the first predetermined value and is equal to or greater than a second predetermined value less than the first predetermined value, the normative regenerative force is a constant value, and
when the rotation speed equivalent value is less than the second predetermined value, the normative regenerative force decreases as the rotation speed equivalent value decreases.

8. The braking control device for a vehicle according to claim 4, wherein
the normative regenerative force is determined such that:
when the rotation speed equivalent value is equal to or greater than a first predetermined value, the normative regenerative force increases as the rotation speed equivalent value decreases,
when the rotation speed equivalent value is less than the first predetermined value and is equal to or greater than a second predetermined value less than the first predetermined value, the normative regenerative force is a constant value, and
when the rotation speed equivalent value is less than the second predetermined value, the normative regenerative force decreases as the rotation speed equivalent value decreases.
